(19) United States
(12) Patent Application Publication
(10) Pub. No.: US 2008/0299865 A1
(43) Pub. Date: Dec. 4, 2008

(54) Separation Apparatus for PDP Panel Assembly and Method for Controlling the Same

(76) Inventors: Byeongun Ko, Kyeonggi-do (KR); Kwangwoo M. Ko, White Bear Lake, MN (US)

Correspondence Address: 3M INNOVATIVE PROPERTIES COMPANY, PO BOX 33427, ST. PAUL, MN, 55133-3427, US

(21) Appl. No.: 11/996,655

(22) PCT Filed: Jul. 27, 2006
(86) PCT No.: PCT/US06/29108

§ 371 Date: Jun. 23, 2008

(30) Foreign Application Priority Data
Aug. 1, 2005 (KR) 10-2005-0070245

(51) Int. Cl. H01J 9/46

(52) U.S. Cl. 445/66

(57) ABSTRACT

The present invention relates to a separation apparatus for separating a PDP (Plasma Display Panel) glass panel and an aluminum frame from a PDP panel assembly (an assembly of the PDP glass panel and the aluminum frame) and a method for controlling the same. The separation apparatus comprises: a working table (including an upper plate and a support section supporting the upper plate supporting the PDP panel assembly, having a PDP glass panel attached to an aluminum frame by the medium of a heat conductive pad or tape and restricting the horizontal movement of the aluminum frame by at least a part of the upper plate; a heater unit provided on one side of the working table for heating the PDP panel assembly on the working table; an actuator mounted to at least two portions on the upper plate of the working table and capable of applying separation forces to the PDP glass panel of the PDP panel assembly by the medium of an impact absorbing part; and a control panel electrically connected to the heater unit and the actuators.

### FIELD OF THE INVENTION

The present invention relates to a separation apparatus for separating both a PDP (Plasma Display Panel) glass panel and an aluminum frame without damage from a PDP panel assembly (an assembly of the PDP glass panel and the aluminum frame) and a method for controlling the same.

### BACKGROUND

In general, a PDP glass panel 2 of a PDP panel assembly 1, as shown in FIGS. 1 and 2, includes a front glass panel 2a and a rear glass panel 2b. A sustain electrode, a dielectric layer, and a protection layer are formed in the front glass panel 2a in turns, and an address electrode, a dielectric layer, a partitioning wall, and a fluorescent body are formed in the rear glass panel 2b in turns. After the two glass panel 2a and 2b are combined with each other, the circumferences of the glass panels are sealed by the medium of a frit glass. A discharging gas or an inert gas is filled in the interior of the glass panels through the gas charging port 3 provided on one side of the rear glass panel 2b and the interior of the glass panels is sealed.

Thereafter, the PDP glass panel 2 is fixed to one surface of an aluminum frame 4 corresponding to the size of the PDP glass panel by the medium of a heat conductive pad 5 or tape 6 so that deformation or damage of the PDP glass panel 2 is prevented.

A protection member 7 having a cylindrical portion 7a surrounding the gas charging port is installed in the gas charging port 3. The protection member 7 is fixed to the aluminum frame 4 around the gas charging port 3 by the medium of a fastener 8. (Refer to FIGS. 3 and 4)

Thereafter, a control PCB (Printed Circuit Board) (not shown) etc. are mounted to the rear surface of the aluminum frame 4 to be finished as one PDP module, the PDP module undergoes various efficiency tests.

During the efficiency tests, the PDP module is determined to be good or inferior. The inferiority is mainly caused by the inferiorities of the electrodes or the partitioning walls, and introduction of foreign substances into the interior of a circuit when manufacturing the product, and exterior impact during the transportation of the product.

The PDP modules determined to be good are transferred to a PDP set manufacturing process to be finished as a PDP set and the PDP modules determined to be inferior are gathered at one place and undergo a post-process.

On the other hand, the PCB (not shown) etc. fixed to the rear surface of the aluminum frame 4 of the PDP module determined to be inferior are separated from the PDP module by the removal of fasteners, and finally the PDP panel assembly 1 comprised of the PDP glass panel 2 and the aluminum frame 4 are only left.

However, since the PDP glass panel 2 and the aluminum frame 4 of the PDP panel assembly 1 are strongly attached by the medium of a heat conductive pad 5 or tape 6, it is difficult to separate the PDP glass panel 2 and the aluminum frame 4 without damage.

Further, since the PDP glass panel 2 and the aluminum frame 4 of the PDP panel assembly 1 are separated by using a dryer (not shown), by applying a heat to the PDP glass panel 2 and the aluminum panel 4 locally and using a long knife to separate the PDP glass panel 2 and the aluminum frame 4, the PDP glass panel 2 or the aluminum frame 4 is deformed during the separation process or the surfaces of them can be damaged by the knife.

### SUMMARY OF THE INVENTION

Accordingly, it is an object of the present invention to provide a separation apparatus for a PDP panel assembly in which a PDP glass panel or an aluminum frame can be separated from the PDP panel assembly and a method for controlling the same.

It is another object of the present invention to provide a separation apparatus for a PDP panel assembly in which only the aluminum frame can be retrieved conveniently to be reused and a method for manufacturing the same, in case of the PDP glass panel of the PDP panel assembly damaged.

In one embodiment of the present invention, there is provided a separation apparatus for a PDP panel assembly comprising: a working table including an upper plate and a support section supporting the upper plate supporting the PDP panel assembly, having a PDP glass panel attached to an aluminum frame by the medium of a heat conductive pad or tape and restricting the horizontal movement of the aluminum frame by at least a part of the upper plate; a heater unit provided on one side of the working table for heating the PDP panel assembly on the working table; an actuator mounted to at least two portions on the upper plate of the working table and capable of applying separation forces to the PDP glass panel of the PDP panel assembly by the medium of an impact absorbing part; and a control panel electrically connected to the heater unit and the actuators.

There is also provided a method for controlling a separation apparatus for a PDP panel assembly according to the present invention comprising the steps of: pivoting at least two actuators having an impact absorbing part attached to the tip ends of operating portions thereof on the PDP panel assembly located on an upper plate of a working table; operating a heater unit, then reading the temperature value of the PDP panel assembly from a temperature sensor at a selected frequency, and displaying the temperature information on a screen display; determining whether the temperature value of the PDP panel assembly is within a separation allowing range of the PDP panel assembly which is stored in a memory of a control panel in advance; and separating the PDP glass panel from an aluminum frame of the PDP panel assembly by operating the operating portions of the actuators if the temperature of the PDP panel assembly is determined to be within the separation allowing range.

### BRIEF DESCRIPTION OF THE DRAWINGS

The present invention will be more apparent from the following detailed description taken in conjunction with the accompanying drawings, in which:

FIG. 1 is a schematic front perspective view of a general PDP panel assembly;

FIG. 2 is a schematic rear perspective view of the PDP panel assembly of FIG. 1;

FIG. 3 is a partially enlarged front perspective view for showing a gas charging port of a general PDP panel assembly;

FIG. 4 is a partially enlarged rear perspective view for showing the gas charging port of FIG. 3;

FIG. 5 is a schematic view of a separation apparatus for a PDP panel assembly according to one embodiment of the present invention;

FIG. 6 is a partially enlarged perspective view of a separation apparatus for a PDP panel assembly according to the present invention;

FIG. 7 is a schematic perspective view of an embodiment showing an operational direction of a pneumatic cylinder and a rotational direction of a PDP glass panel of a PDP panel assembly in case the rotational center of the PDP glass panel is determined to a gas charging port;

FIG. 8 is a schematic perspective view for showing an operational direction of a pneumatic cylinder and a rotational direction of a PDP glass panel of a PDP panel assembly in case the rotational center of the PDP glass panel is determined to a center of the PDP glass panel; and

FIG. 9 is a flow chart for explaining a method for controlling a separation apparatus for a PDP panel assembly according to one embodiment of the present invention.

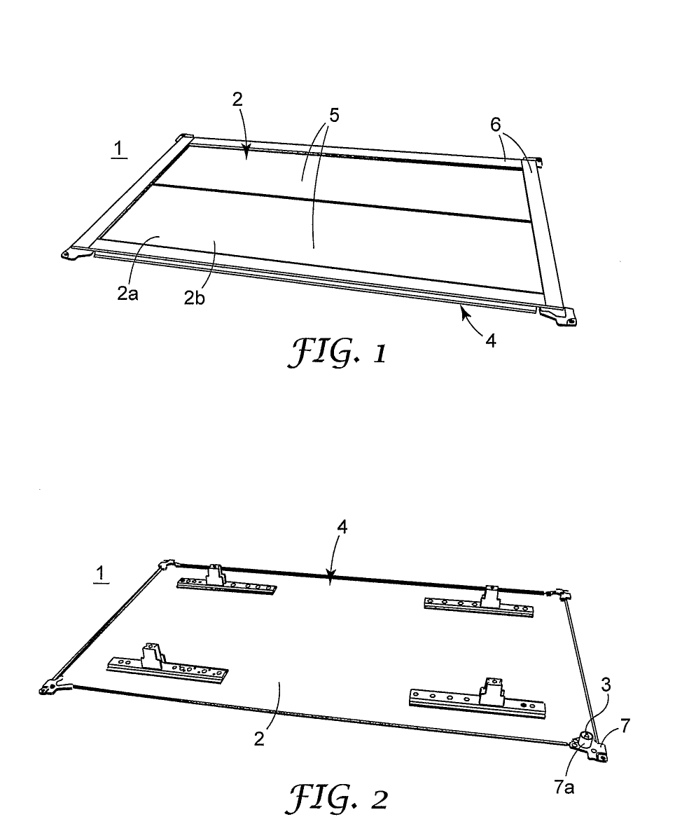

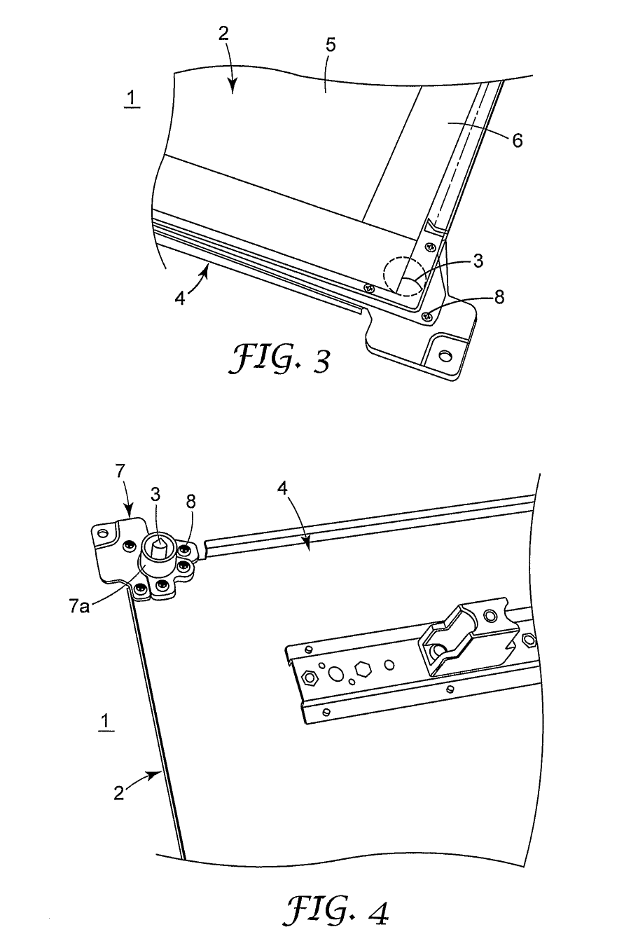

### DETAILED DESCRIPTION

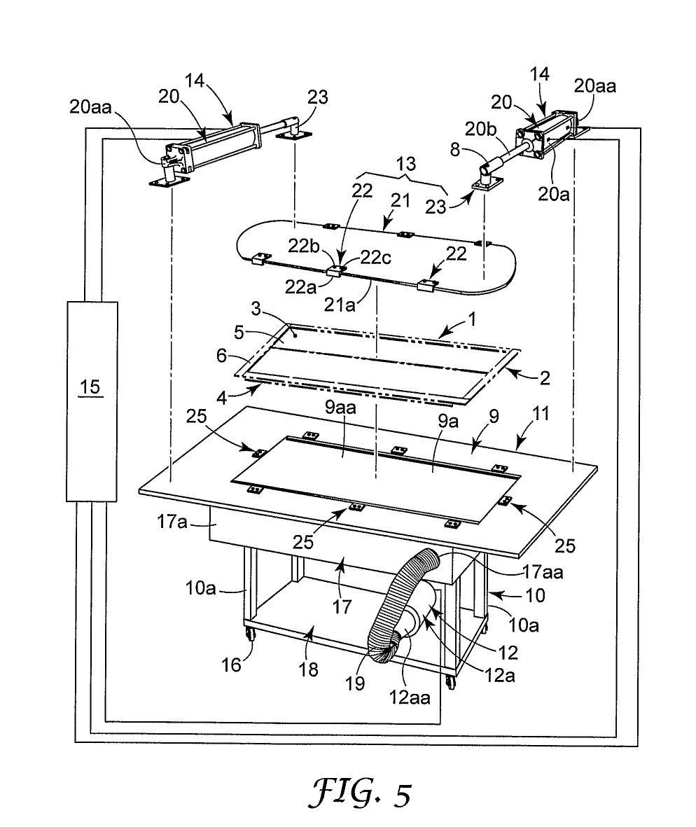

Hereinafter, embodiments of the present invention will be described with reference to FIGS. 5 to 8.

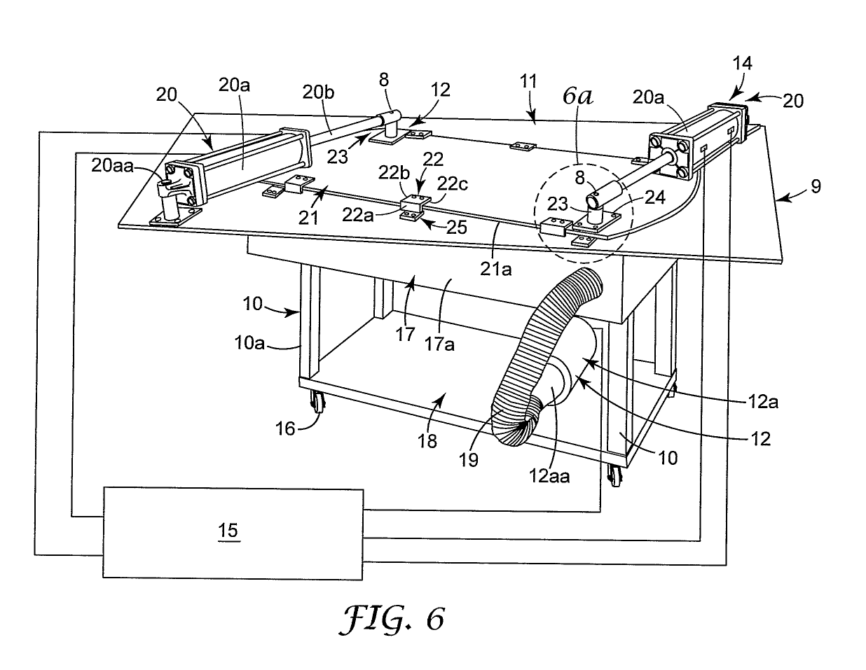

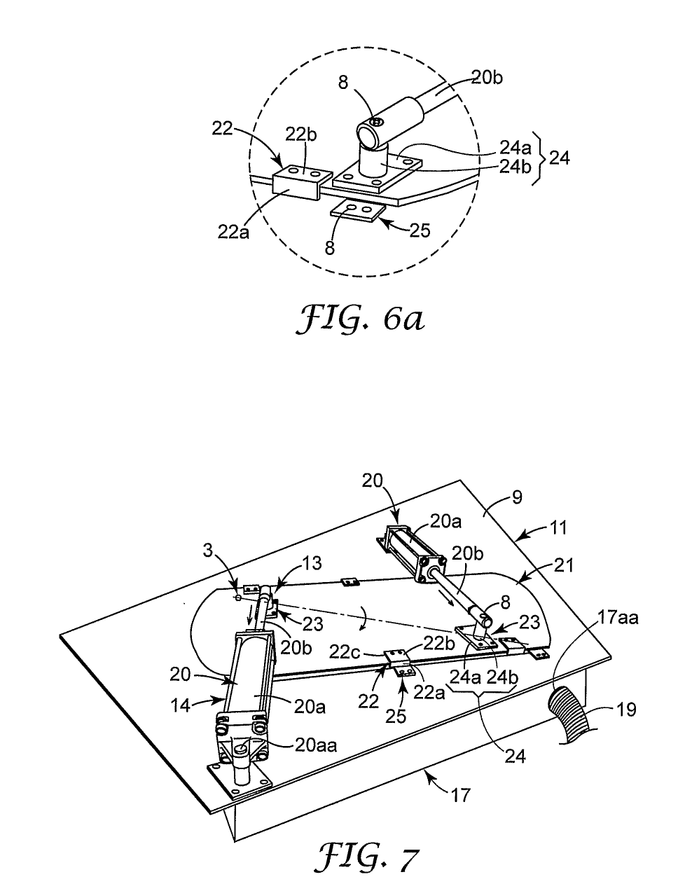

FIG. 5 is a schematic view of a separation apparatus for a PDP panel assembly according to the present invention. FIG. 6 is a partially enlarged perspective view of a separation apparatus for a PDP panel assembly according to the present invention.

As shown in FIG. 5, a separation apparatus for a PDP panel assembly according to one embodiment of the present invention includes a working table 11 including an upper plate 9 and a support section 10 supporting the upper plate 9 supporting the PDP panel assembly 1, having a PDP glass panel 2 attached to an aluminum frame 4 by the medium of a heat conductive pad 5 or tape 6 and restricting the horizontal movement of the aluminum frame 4 by at least a part of the upper plate; a heater unit 12 provided on one side of the working table 11 for heating the PDP panel assembly 1 on the working table 11; an actuator 14 mounted to at least two portions on the upper plate 9 of the working table 11 and capable of applying separation forces to the PDP glass panel 2 of the PDP panel assembly 1 by the medium of an impact absorbing part 13; and a control panel 15 electrically connected to the heater unit 12 and the actuators 14 for heating the PDP panel assembly 1 through the heater unit 12 and applying the separation forces to the PDP glass panel through the actuators 14 if the PDP panel assembly 1 reaches a predetermined temperature.

Here, it is preferable that a recessed portion 9a having a predetermined depth with respect to the upper surface of the upper plate 9 is formed on the upper plate 9 of the working table 11 and capable of restricting the horizontal movement of the aluminum frame 4.

An opening portion 9aa can be formed in the recessed portion 9a of the upper plate 9 so that the heat supplied from the heater unit 12 can be transferred to the aluminum frame 4 directly. The size of the opening portion 9aa of the recessed portion 9a is enough if it can support at least two opposite edges of the aluminum frame 4.

On the other hand, it is preferable that, in case the PDP glass panel 2 is to be separated from the aluminum frame 4 in a state in which resin members (a protection member 7 for a gas charging port 3 etc.) are not removed from the corner portions of the aluminum frame 4 of the PDP panel assembly 1, the corresponding portions on the corner sides of the recess portion 9a of the upper plate 9 are recessed or cut.

The heater unit 12 can be a hot-air heater 12a, an infrared lamp, a conduction type heater, an induction type heater, or a combination thereof. A heat source of the heater unit 12 may be from a fuel gas or oil as well as electricity.

In one embodiment, it is preferable that the support section 10 of the working table 11 includes at least two support members 10a to support the upper plate 9 stably and a roller 16 is provided at a lower end of at least two of the support members 10a, respectively. (Refer to FIG. 6)

The heater unit 12 includes a hot-air heater 12a. On the lower side of the upper plate 9 are further provided a partitioning wall portion 17 separated from the opening portion 9aa by a predetermined distance, sealing the opening portion 9aa of the upper plate 9 so as to seal the opening portion 9aa from outside, and having an inlet port 17aa on one side wall 17a thereof, and a base plate 18 fixed on the lower side of the partitioning wall portion 17 by the medium of the support section 10. The hot-air heater 12a is disposed on the base plate 18 and an outlet port 12aa of the hot-air heater 12a is connected to the inlet port 17aa of the partitioning wall portion 17 by the medium of a guide tube 19. (Refer to FIG. 6)

It is preferable that the separation temperature of the PDP panel assembly 1 is within 50 to 90 degrees Celsius. A laminar flow generating section (not shown) can be further provided between the upper plate 9 supporting the PDP panel assembly 1 and the hot-air heater 12a so that the hot air from the hot-air heater 12a can be substantially uniformly transferred to the PDP panel assembly in a laminar flow type.

Any apparatus in which an operating portion thereof can be moved to the front and rear sides is possible as the actuator 14, as well as a hydraulic or pneumatic cylinder, and the pneumatic cylinder 20 is preferable. The pneumatic cylinder 20 can be pivoted to the right and left sides about the rear end 20aa of the body portion 20a on the upper plate 9 of the working table 11. A tip end of the operating portion 20b of the pneumatic cylinder 20 is detachably fixed to the PDP glass panel 2 of the PDP panel assembly 1 by the medium of an impact absorbing part 13. (Refer to FIGS. 6 to 8)

The impact absorbing part 13 includes a cover plate 21, first fixing pieces 22, and an engagement medium member 23. The cover plate 21 includes an impact absorbing layer 21a on the lower surface thereof so that the impact absorbing layer 21a makes contact with the PDP glass panel 2 of the PDP panel assembly 1. The tip ends 22a of the first fixing pieces 22 face the edge side surface of the PDP glass panel 2 and the body portions 22b of the fixing pieces 22 face the upper surface of the cover plate 21. An impact absorbing layers 22c are provided on the lower surfaces of the first fixing pieces 22. The body portions 22b of each of the first fixing pieces 22 are attached to the cover plate 21 by the medium of at least one fastener 8. The engagement medium member 23 detachably fix the tip ends of the operating portions 20b of the pneumatic cylinders 20 to corresponding portions of the cover plate 21, respectively.

The cover plate 21 of the impact absorbing part 13, as shown in FIGS. 5 to 8, can be not only in a single type in which it corresponds to both the two pneumatic cylinders 20 but also in a separation type in which it corresponds to the pneumatic cylinders 20 separately. The cover plate 21 of the impact absorbing part 13 can be made of a reinforced plastic or metal.

It is preferable that the impact absorbing layers 21a and 22c of each of the cover plate 21 and the first fixing pieces 22 are formed of a textile fabric, a resin, and a combination thereof. Further, it should be understood that the resin includes a rubber. Each of the impact absorbing layers 21a and 22c can be fixed to corresponding part of the cover plate 21 and the first fixing pieces 22 by the medium of an adhesive or by a thermal fusion.

Each of the engagement medium members 23 includes a connecting piece 24 having a base portion 24a on one side thereof and a column portion 24b on the other side thereof, and detachably affixing the base portion 24b of the connecting piece 24 to a corresponding portion of the cover plate 21 and the column portion 24b to the tip end of the corresponding operating portion 20b by the medium of at least one fastener 8, respectively.

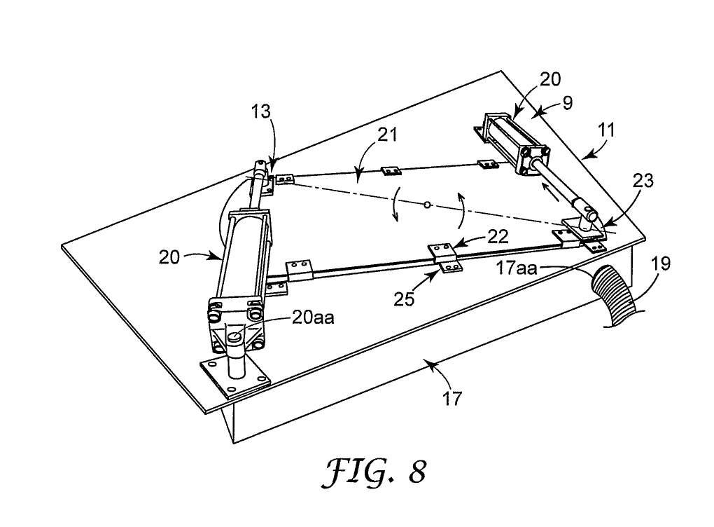

Second fixing pieces 25 can be further provided on the upper plate 9 of the working table 11 to at least partially restrict the horizontal movement of the aluminum frame 4 having a different thickness according to the kind of the PDP. (Refer to FIGS. 7 and 8)

It is preferable that the rotational center of the PDP glass panel 2 is any one of the gas charging port 3 of the PDP glass panel and the center of the PDP glass panel. (Refer to FIGS. 7 and 8)

Here, if both the PDP glass panel 2 and the aluminum frame 4 of the PDP panel assembly 1 are to be separated completely, the rotational center of the PDP glass panel 2 should be the gas charging port 3. Further, if only the aluminum frame 4 is to be separated completely, the rotational center should be the center of the PDP glass panel 2.

The rotational center of the PDP glass panel 2 determines operational directions of operating portions 20b of the actuators 14 or 20 controlled by the control panel 15.

In one embodiment, it is preferable that a thermometer (not shown) for checking the temperature of the aluminum frame 4 or the PDP glass panel 2 of the PDP panel assembly 1 is provided on the working table 11 and function keys (not shown) corresponding to the heater unit 12 and the actuators 14 are provided in the control panel 15.

Therefore, operator checks the temperature of the PDP glass panel 2 by using the thermometer and can control the heater unit 12 and the actuator 14 by using the function keys of the control panel 15.

On the other hand, according to another preferred embodiment of the present invention, a temperature sensor (not shown) for checking the temperature of the aluminum frame 4 or the PDP glass panel 2 of the PDP panel assembly 1 is provided on the working table 11 and is electrically connected to a microcomputer of the control panel 15. Further, a screen display (not shown) for displaying the temperature value detected from the temperature sensor is further provided in the control panel 15.

Accordingly, the microcomputer of the control panel 15 receives the temperature information of the PDP glass panel 2 from the temperature sensor and displays the information on the screen display. Further, the microcomputer of the control panel 15 determines whether the temperature value of the PDP panel assembly 1 is within the separation allowing range of the PDP panel assembly 1 which is stored in a memory of the control panel 15 in advance and controls the heater unit 12 and the actuators 14 based on the determination.

On the other hand, the operation of the microcomputer of the control panel 15 can be interrupted by function keys provided in the control panel, and operator can control the heater unit 12 and the actuators 14 through the corresponding function keys by converting the mode of the separation apparatus of the present invention from the automatic or semi-automatic mode to the manual mode, if necessary.

On the other hand, the screen display can be a touch screen enabling the control of the heating unit 12 and the actuator 14 in the on screen display manner. Accordingly, operator can control the heater unit 12 and the actuators 14 by using the display menu on the screen display without using function keys of the control panel 15.

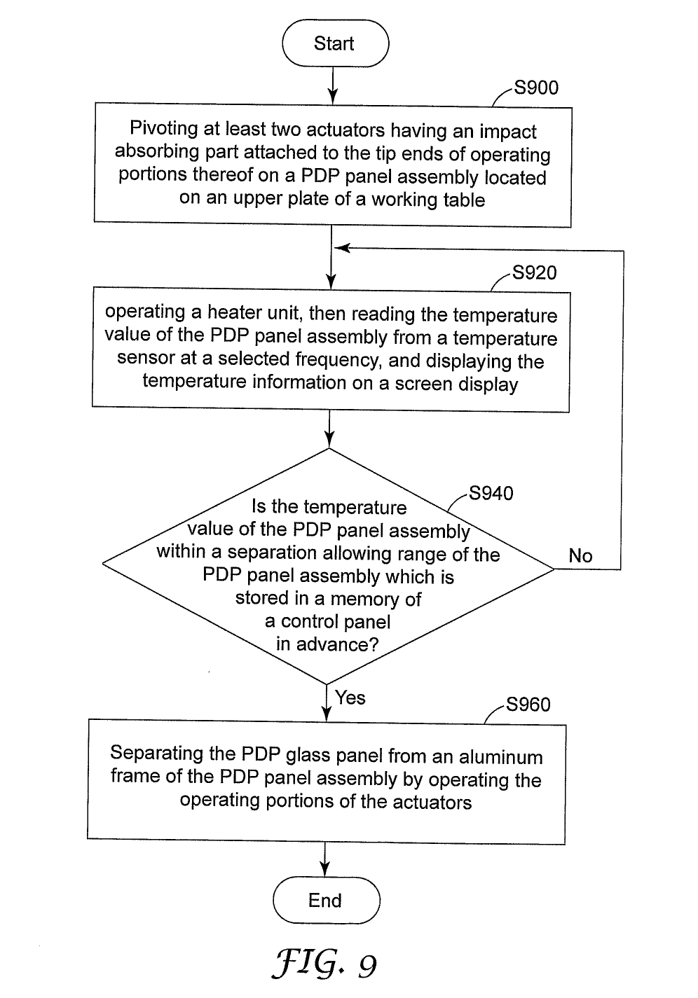

Hereinafter, a method for controlling the separation apparatus for a PDP panel assembly according to the present invention will be described with reference to FIG. 9.

First, by a human power or by using an apparatus, the PDP panel assembly 1 is moved into the recess portion 9a of the upper plate 9 of the working table 11 and is positioned such that the aluminum frame 4 of the PDP panel assembly 1 faces the recess portion 9a.

Then, the aluminum frame 4 of the PDP panel assembly 1 is received in the recess portion 9a of the upper plate 9 to a predetermined depth and the PDP glass panel 2 of the PDP panel assembly 1 is exposed to the upper surface of the upper plate 9.

Thereafter, both the two actuators 14 having an impact absorbing part 13 attached to the tip ends of operating portions 20b thereof are pivoted on the PDP panel assembly 1 located on the upper plate 9 of the working table 11 by using the control panel 15 (S900).

Thereafter, if the heater unit 12 is operated through the control panel 15, the microcomputer of the control panel 15 reads the temperature value of the PDP panel assembly 1 from the temperature sensor (not shown) at a selected frequency and displays the temperature information on the screen display (not shown) (S920).

Then, in case the heater unit 12 is the hot-air heater 12a and the opening portion 9aa is provided in the recess portion 9a, the hot air supplied from the hot-air heater 12a to the opening portion 9aa of the recess portion 9a of the upper plate 9 through the guide tube 19 heats the aluminum frame 4 of the PDP panel assembly 1.

Thereafter, the microcomputer of the control panel 15 determines whether the temperature value of the PDP panel assembly 1 is within the separation allowing range of the PDP panel assembly 1 which is stored in a memory of the control panel 15 in advance (S940).

If the temperature of the PDP panel assembly 1 is determined to be within the separation allowing range, the microcomputer of the control panel 15 operates the operating portion of both the two actuators 14 or 20 and separates the PDP glass panel 2 from the aluminum frame 4 of the PDP panel assembly 1 (S960).

On the other hand, the temperature value of the PDP panel assembly 1 in the temperature information displaying step (S920) is determined from any one of the temperature value of the aluminum frame 4 and the temperature value of the PDP glass panel 2.

In one step (one step among S900 to S940) before the separation of the PDP glass panel, a step in which operator is requested to confirm whether the rotational center of the PDP glass panel 2 is the gas charging port 3 of the PDP glass panel or the center of the PDP glass panel 2 can be further comprised.

It is preferable that the result value in the determination step (S940) is displayed on the screen display (not shown) to help operator understand the work proceeding situation.

As above-described, according to the present invention, both the PDP glass panel and the aluminum frame can be separated from the PDP panel assembly which is determined to be an inferior goods quickly and simply without damage to reuse the PDP glass panel and the aluminum frame in the PDP manufacturing field.

Further, in case the PDP glass panel of the PDP panel assembly is damaged, the aluminum frame can be retrieved conveniently to be reused.

Although a preferred embodiment of the present invention has been described for illustrative purposes, those skilled in the art will appreciate that various modifications, additions and substitutions are possible, without departing from the scope and spirit of the invention as disclosed in the accompanying claims.

1-26. (canceled)

27. A separation apparatus for a PDP (Plasma Display Panel) panel assembly comprising:
a working table including an upper plate and a support section supporting the upper plate supporting the PDP panel assembly, having a PDP glass panel attached to an aluminum frame by the medium of a heat conductive pad or tape and restricting the horizontal movement of the aluminum frame by at least a part of the upper plate;
a heater unit provided on one side of the working table for heating the PDP panel assembly on the working table,
an actuator mounted to at least two portions on the upper plate of the working table and capable of applying separation forces to the PDP glass panel of the PDP panel assembly by the medium of an impact absorbing part; and
a control panel electrically connected to the heater unit and the actuators.

28. A separation apparatus for a PDP panel assembly according to claim 27, further comprising a recessed portion having a predetermined depth with respect to the upper surface of the upper plate, formed on the upper plate of the working table and capable of restricting the horizontal movement of the aluminum frame.

29. A separation apparatus for a PDP panel assembly according to claim 28, wherein an opening portion is formed in the recessed portion of the upper plate so that the heat supplied from the heater unit can be transferred to the aluminum frame directly.

30. A separation apparatus for a PDP panel assembly according to claim 27, wherein the heater unit is a hot-air heater, an infrared lamp, a conduction type heater, an induction type heater, or a combination thereof.

31. A separation apparatus for a PDP panel assembly according to claim 27, wherein the support section of the working table includes at least two support members.

32. A separation apparatus for a PDP panel assembly according to claim 27, wherein the heater unit is a hot-air heater, and oil the lower side of the upper plate are further provided a partitioning wall portion separated from the opening portion by a predetermined distance, sealing the opening portion of the upper plate from outside and having an inlet port on one side wall thereof and a base plate fixed on the lower side of the partitioning wall portion by the medium of the support section, and the hot-air heater is disposed on the base plate, and an outlet port of the hot-air heater is connected to the inlet port of the partitioning wall portion by the medium of a guide tube.

33. A separation apparatus for a PDP panel assembly according to claim 32, wherein a laminar flow generating section is provided between the upper plate and the hot-air heater so that the hot air from the hot-air heater can be substantially uniformly transferred to the PDP panel assembly in a laminar flow type.

34. A separation apparatus for a PDP panel assembly according to claim 27, wherein the heater unit is a hot-air heater, and the hot-air heater is capable of providing the separation temperature of the PDP panel assembly within 50 to 90 degrees Celsius.

35. A separation apparatus for a PDP panel assembly according to claim 27, wherein the actuator is an pneumatic cylinder, and the pneumatic cylinder can be pivoted to the right and left sides about the rear end of the body portion on the upper plate of the working table, and a tip end of an operating portion of the pneumatic cylinder is detachably fixed to the PDP glass panel of the PDP panel assembly by the medium of the impact absorbing part.

36. A separation apparatus for a PDP panel assembly according to claim 27, wherein the impact absorbing part includes a cover plate having an impact absorbing layer on the lower surface thereof so as to makes contact with the PDP glass panel of the PDP panel assembly, first fixing pieces each of which has a tip end facing the edge side surface of the PDP glass panel, a body portion facing the upper surface of the cover plate, and an impact absorbing layer on the lower surface thereof, the body portion of each of the first fixing pieces being attached to the cover plate by the medium of at least one fastener, and an engagement medium member detachably fixing the tip ends of the operating portions of the pneumatic cylinders to corresponding portions of the cover plate, respectively.

37. A separation apparatus for a PDP panel assembly according to claim 36, wherein the impact absorbing layers of each of the cover plate and the first fixing pieces are formed of a textile fabric, a resin, and a combination thereof.

38. A separation apparatus for a PDP panel assembly according to claim 37, wherein the resin includes a rubber.

39. A separation apparatus for a PDP panel assembly according to claim 36, wherein each of the engagement medium members includes a connecting piece having a base portion on one side thereof and a column portion on the other side thereof, and detachably affixing the base portion of the connecting piece to a corresponding portion of the cover plate and the column portion to the tip end of the corresponding operating portion, respectively.

40. A separation apparatus for a PDP panel assembly according to claim 27, wherein second fixing pieces are further provided on the upper plate of the working table to at least partially restrict the horizontal movement of the aluminum frame.

41. A separation apparatus for a PDP panel assembly according to claim 27, wherein the rotational center of the PDP glass panel is any one of a gas charging port of the PDP glass panel and the center of the PDP glass panel.

42. A separation apparatus for a PDP panel assembly according to claim 27, wherein a temperature sensor for checking the temperature of the aluminum frame or the PDP glass panel of the PDP panel assembly is provided on the working table and is electrically connected to a microcomputer of the control panel.

43. A method for controlling a separation apparatus for a PDP (Plasma Display Panel) panel assembly, which comprises:
pivoting at least two actuators having an impact absorbing part attached to the tip ends of operating portions thereof on the PDP panel assembly located on an upper plate of a working table;
operating a heater unit, then reading the temperature value of the PDP panel assembly from a temperature sensor at a selected frequency, and displaying the temperature information on a screen display;
determining whether the temperature value of the PDP panel assembly is within a separation allowing range of the PDP panel assembly which is stored in a memory of a control panel in advance; and
separating the PDP glass panel from an aluminum frame of the PDP panel assembly by operating the operating portions of the actuators if the temperature of the PDP panel assembly is determined to be within the separation allowing range.

44. A method according to claim 43, wherein the temperature value of the PDP panel assembly in the temperature information displaying step is determined from at least one of the temperature values of the aluminum frame and the PDP glass panel.
